(19) United States
(12) Patent Application Publication
(10) Pub. No.: US 2026/0290295 A1
(43) Pub. Date: Sep. 24, 2026

(54) KEYBOARD DEVICE AND KEYBOARD DEVICE ASSEMBLY METHOD

(71) Applicant: CASIO COMPUTER CO., LTD., Tokyo (JP)

(72) Inventors: Naoya ISHIBASHI, Tokyo (JP); Akihito AKAISHI, Tokyo (JP)

(73) Assignee: CASIO COMPUTER CO., LTD., Tokyo (JP)

(21) Appl. No.: 19/569,803

(22) Filed: Mar. 17, 2026

(30) Foreign Application Priority Data
Mar. 19, 2025 (JP) 2025-044576

(51) Int. Cl. G10H 1/34; G10C 3/12

(52) U.S. Cl. CPC G10H 1/344; G10C 3/12; G10H 2220/221; G10H 2220/291

(57) ABSTRACT

A keyboard device includes: a lower case; a board disposed above the lower case; keys disposed above the board; a reinforcement member disposed between the lower case and the board; and a stopper attachment that is part of the reinforcement member. The stopper attachment is at a position higher than the board.

### CROSS-REFERENCE TO RELATED APPLICATIONS

This application is based upon and claims the benefit of priority from the prior Japanese Patent Application No. 2025-044576, filed on March 19, 2025, the entire contents of which are incorporated herein by reference.

### BACKGROUND OF THE INVENTION

### TECHNICAL FIELD

The present disclosure relates to a keyboard device, such as an electronic piano and electronic organ, and a method of assembling the keyboard device.

### DESCRIPTION OF RELATED ART

In a known keyboard device, such as the one described in Japanese Unexamined Patent Application Publication No. 2021-18267, a board attachment part and a key attachment part are provided to a lower case; a switch board is attached to the board attachment part; and keys are attached to the key attachment part in the state where the keys are arranged above the switch board.

### SUMMARY OF THE INVENTION

An object of the present disclosure is to provide a thin keyboard device that is easy to assemble and a method of assembling the keyboard device.

According to the present disclosure, a keyboard device includes: a lower case; a board disposed above the lower case; keys disposed above the board; a reinforcement member disposed between the lower case and the board; and a stopper attachment that is part of the reinforcement member, wherein the stopper attachment is at a position higher than the board.

According to the present disclosure, a keyboard device assembly method includes: a first process of assembling a keyboard unit by providing a reinforcement member under a component attachment member on which a board and keys have been mounted; and a second process of combining the keyboard unit with a lower case.

### BRIEF DESCRIPTION OF DRAWINGS

FIG. 1 is a perspective view of a keyboard instrument as an embodiment of the present disclosure.

FIG. 2 is a plan view of the keyboard instrument shown in FIG. 1.

FIG. 3 is an enlarged cross-sectional view of the keyboard instrument shown in FIG. 2 along the A-A line and viewed in arrows A.

FIG. 4 is an enlarged cross-sectional view of the main part of the keyboard instrument in FIG. 3, wherein a keyboard unit is placed on a lower case.

FIG. 5 is an enlarged cross-sectional view of a switch on a switch board in the keyboard unit shown in FIG. 4.

### DETAILED DESCRIPTION

In the present disclosure, the left-right direction refers to the leftward and rightward directions from the position where a player of a keyboard instrument 1 stands. For the top-bottom direction, the top surface of the keyboard instrument 1 is defined as the surface on which a keyboard unit 4 is mounted, and the bottom surface is defined as the surface opposite the top surface. For the front-back direction, the front side is defined as the player's side, and the back side is defined as the side opposite the front side.

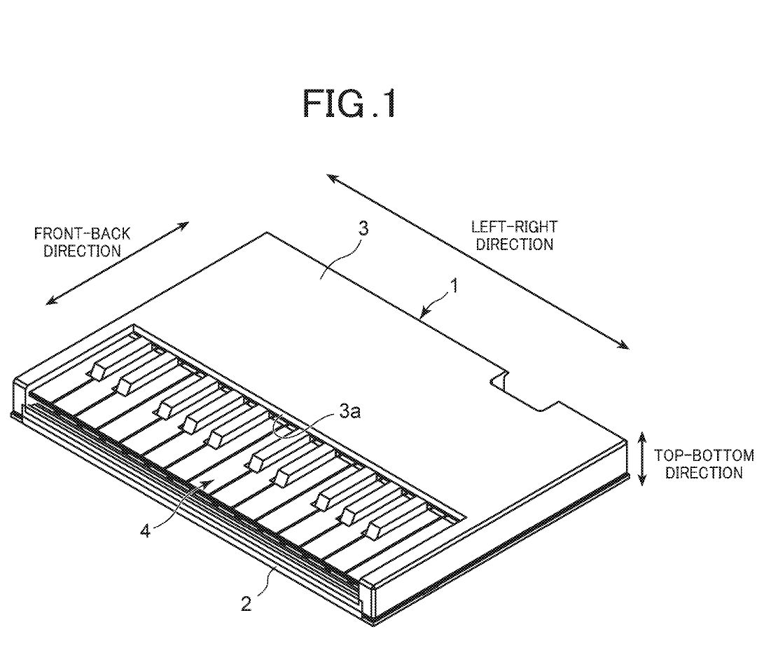

Hereinafter, a keyboard instrument as an embodiment of the present disclosure will be described with reference to FIGS. 1 to 5.

The keyboard instrument is a mini keyboard instrument as a keyboard device, as shown in FIGS. 1 to 3. The keyboard instrument includes an instrument case 1. The instrument case 1 includes a lower case 2 and an upper case 3. The lower case 2 is substantially box-shaped and elongated in the widthwise direction. The top side of the lower case 2 is open. The bottom side of the upper case 3 is open. The front side of the upper case 3 has an opening 3a and is open except both sides of the opening 3a in the left-right direction. The upper case 3 is laid on the lower case 2 and attached to the lower case 2 with non-illustrated screws. The keyboard unit 4 of the instrument case 1 is substantially half the A4 size. The entire instrument is substantially the A4 size.

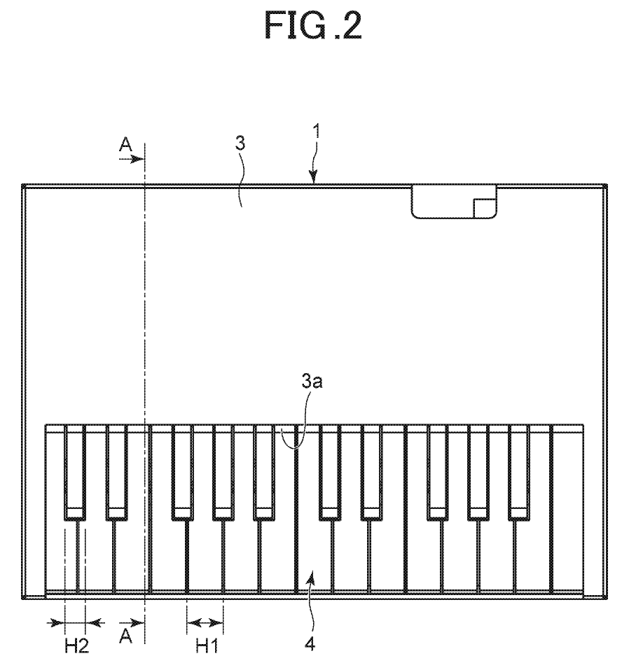

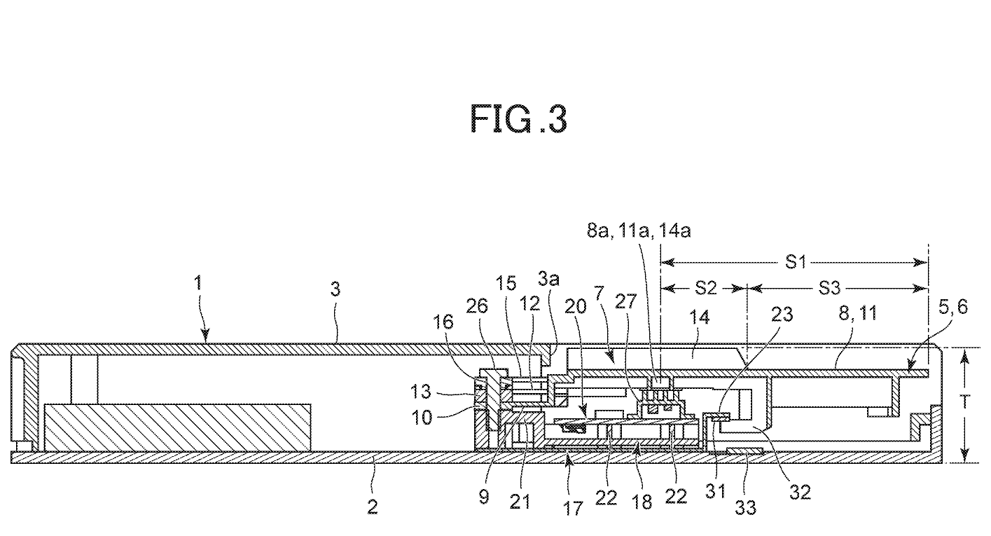

In addition to the keyboard unit 4 shown in FIGS. 1 and 2, the instrument case 1 includes a non-illustrated display, switches, and speaker. The keyboard unit 4 includes a first white key unit 5, a second white key unit 6, and a black key unit 7, as shown in FIG. 3. In the instrument case 1, the keyboard unit 4 is exposed upward from the opening 3a of the upper case 3 except the back sides of the first white key unit 5, the second white key unit 6, and the black key unit 7.

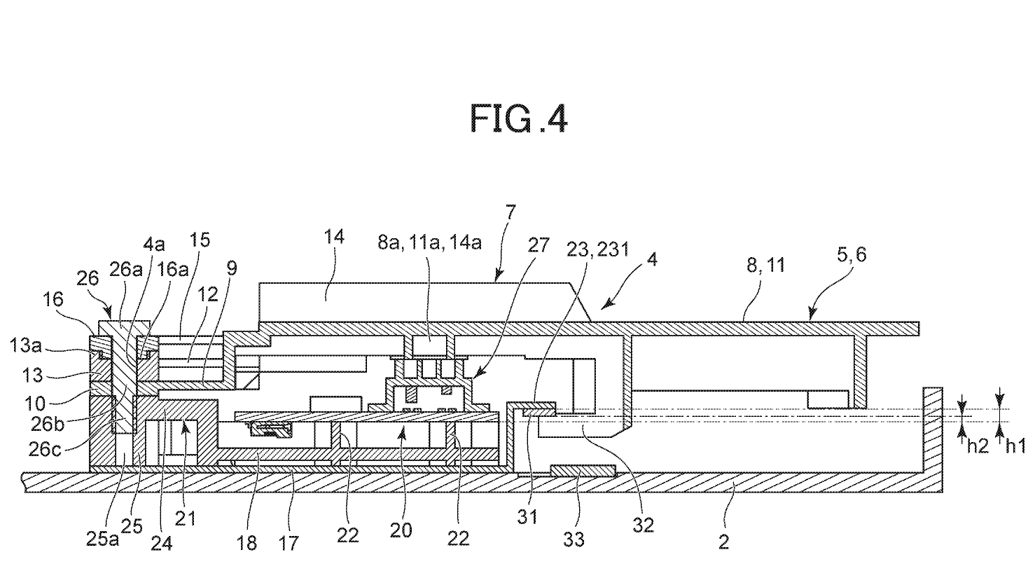

As shown in FIGS. 3 and 4, the first white key unit 5 includes multiple first white keys 8. The first white keys 8 are arranged at predetermined intervals and connected to a first key connection part 10 via the respective first bending parts 9 so as to receive key press operations. The first white keys 8, the first bending parts 9, and the first key connection part 10 are unitarily formed of synthetic resin. The first key connection part 10 has a plate shape elongated in the direction in which the first white keys 8 are arranged. One end of each first bending part 9 is connected to the bottom of the back end of the corresponding first white key 8. The other end of each first bending part 9 is connected to the first key connection part 10. The first bending part 9 bends and deforms in the top-bottom direction on the other end thereof as a fulcrum, so that the first white key 8 swings in the top-bottom direction.

As shown in FIGS. 3 and 4, the second white key unit 6 includes multiple second white keys 11 each of which is disposed between the first white keys 8, which are arranged at predetermined intervals, of the first white key unit 5. Similarly to the first white key unit 5, the second white keys 11 of the second white key unit 6 are connected to the second key connection part 13 via the respective second bending parts 12 so as to receive key press operations. The second white keys 11, the second bending parts 12, and the second key connection part 13 are unitarily formed of synthetic resin.

As shown in FIGS. 3 and 4, similarly to the first key connection part 10, the second key connection part 13 has a plate shape elongated in the direction in which the second white keys 11 are arranged. The second key connection part 13 is disposed on the first key connection part 10. Similarly to the first bending parts 9, one end of each second bending part 12 is connected to around the middle part in the top-bottom direction of the back-end part of the corresponding second white key 11. The other end of the second bending part 12 is connected to the second key connection part 13. The second bending part 12 bends and deforms in the top-bottom direction on the other end thereof as a fulcrum, so that the second white key 11 swings in the top-bottom direction.

The black key unit 7 includes black keys 14 that are disposed between the first white keys 8 of the first white key unit 5 and the second white keys 11 of the second white key unit 6, as shown in FIGS. 3 and 4. Similarly to the first white key unit 5 and the second white key unit 6, the black keys 14 of the black key unit 7 are connected to the third key connection part 16 via the respective third bending parts 15 so as to receive key press operations. The black keys 14, the third bending parts 15, and the third key connection part 16 are unitarily formed of synthetic resin.

As shown in FIGS. 3 and 4, the third key connection part 16 has a plate shape elongated in the direction in which the black keys 14 are arranged, similarly to the first key connection part 10 and the second key connection part 13. The third key connection part 16 is disposed on the second key connection part 13. Similarly to the first bending parts 9 and the second bending parts 12, one end of each third bending part 15 is connected to the top part of the back end of the corresponding black key 14. The other end of the third bending part 15 is connected to the third key connection part 16. The third bending part 15 bends and deforms in the top-bottom direction on the other end thereof as a fulcrum, so that the black key 14 swings in the top-bottom direction.

As shown in FIGS. 3 and 4, in the keyboard unit 4, the second white keys 11 of the second white key unit 6 are disposed between the first white keys 8 of the first white key unit 5 from above; and the second key connection part 13 of the second white key unit 6 is laid on the first key connection part 10 of the first white key unit 5. The second bending parts 12 are separate from the first bending parts 9 by a certain distance in the top-bottom direction and are offset from the first bending parts 9 in the key arrangement direction. Thus, the first bending parts 9 and the second bending parts 12 are arranged to avoid contact with each other. On the top surface of the second key connection part 13 of the second white key unit 6, a pair of upward protrusions 13a is formed along the direction in which the second white keys 11 are arranged. The pair of upward protrusions 13a engage with a pair of downward protrusions 16a formed on the third key connection part 16 of the black key unit 7.

As shown in FIG. 4, in the keyboard unit 4, the black keys 14 are arranged between the first white keys 8 of the first white key unit 5 and the second white keys 11 of the second white key unit 6 from above; and the third key connection part 16 of the black key unit 7 is laid on the second key connection part 13 of the second white key unit 6. The pair of downward protrusions 16a of the third key connection part 16 of the black key unit 7 engages with the pair of upward protrusions 13a on the top surface of the second key connection part 13 of the second white key unit 6. Thus, the third key connection part 16 is disposed on the second key connection part 13. The third bending parts 15 are separate from the second bending parts 12 by a certain distance in the top-bottom direction and are offset from the second bending parts 12 in the key arrangement direction. Thus, the second bending parts 12 and the third bending parts 15 are arranged to avoid contact with each other. In the key arrangement direction, the width of the third bending parts 15 of the black keys is narrower than the width of the first bending parts 9 of the first white keys 8 and the width of the second bending parts 12 of the second white keys 11.

As shown in FIGS. 1 to 3, the keyboard unit 4 is mounted inside the lower case 2 in the state where the first white keys 8, the second white keys 11, and the black keys 14 are exposed upward through the opening 3a of the upper case 3. The keyboard unit 4 includes a reinforcement member 17, a component attachment member 18, and a switch board 20. The reinforcement member 17 is a rigid metal reinforcement plate. The reinforcement member 17 is formed of a metal plate, such as steel electrolytic cold commercial (SECC) or steel use stainless (SUS) sheet, for example. The reinforcement member 17 is placed on the lower case 2 and attached to the lower case 2 with non-illustrated screws. At the front end of the reinforcement member 17, namely at the front end located at the front side of the keyboard unit 4, a stopper attachment 231 (described later) is provided.

As shown in FIGS. 3 and 4, the component attachment member 18 is placed on the reinforcement member 17 and attached to the reinforcement member 17 with non-illustrated screws. The component attachment member 18 is made of synthetic resin. The component attachment member 18 includes a key attachment part 21 and a board attachment part 22. The key attachment part 21 is for supporting the first white keys 8, the second white keys 11, and the black keys 14. The key attachment part 21 is formed at the back-end side (the left end side in FIG. 4) of the component attachment member 18. On the key attachment part 21, the first to third key connection parts 10, 13, and 16 of the keyboard unit 4 are laid on each other and attached to the key attachment part 21 by screws 26. The key attachment part 21 has a base 24 and bosses 25. The base 24 is provided at the back-end side of the component attachment member 18. The bosses 25 are formed on the base 24 and have screw holes 25a into which the screws 26 are screwed.

As shown in FIGS. 3 and 4, the base 24 is slightly taller in the top-bottom direction than the switch board 20 (described later) that is provided on the board attachment member 22. The bosses 25 are provided on the base 24 at predetermined intervals in the key arrangement direction. Each of the screws 26 has a head 26a, a shank 26b, and a screw portion 26c. The first to third key connection parts 10, 13, and 16 of the first white key unit 5, the second white key unit 6, and the black key unit 7 are laid on each other in this order in the top-bottom direction. In this state, the shanks 26b of the screws 26 are inserted to the screw insertion holes 4a formed in the first to third key connection parts 10, 13, and 16. The screw portions 26c of the screws 26 are then screwed to the screw holes 25a of the bosses 25. Thus, the first to third key connection parts 10, 13, and 16 are attached to the base 24 in the state of being pressed against the base 24 by the heads 26a of the screws 26.

As shown in FIGS. 3 and 4, the board attachment part 22 includes multiple support ribs on which the switch board 20 is arranged and mounted. The board attachment part 22 erects on the component attachment member 18 that is located at the front side of the base 24 (the right side in FIG. 4), namely at around the middle in the front-back direction of the first white keys 8, the second white keys 11, and the black keys 14 of the keyboard unit 4. The switch board 20 has a plate shape elongated in the key arrangement direction. The switch board 20 is mounted on the board attachment part 22 with non-illustrated screws. On the top surface of the switch board 20, multiple switches 27 are provided. The switches 27 correspond to switch press parts 8a of the first white keys 8, switch press parts 11a of the second white keys 11, and switch press parts 14a of the black keys 14, respectively, of the keyboard unit 4.

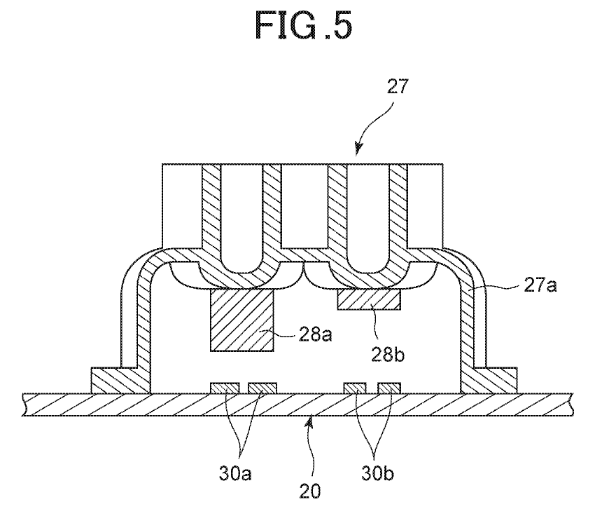

As shown in FIG. 4, when the first white keys 8, second white keys 11, and black keys 14 are pressed, the switch press parts 8a, 11a, and 14a of the first white keys 8, the second white keys 11, and the black keys 14 press the corresponding switches 27, so that the switches 27 perform switch operations. The switches 27 are formed of a rubber sheet elongated in the key arrangement direction. Multiple domal parts 27a of the switches 27 are bulged from the rubber sheet to correspond to the respective switch press parts 8a, 11a, and 14a of the first white keys 8, the second white keys 11, and the black keys 14, as shown in FIG. 5.

As shown in FIG. 5, each of the switches 27 includes: a first movable contact part 28a and a second movable contact part 28b formed on the inner upper surface of the domal part 27a; and a pair of first fixed contact parts 30a and a pair of second fixed contact parts 30b formed on the switch board 20 inside the domal part 27a. The first movable contact part 28a corresponds to the pair of first fixed contact parts 30a. The second movable contact part 28b corresponds to the pair of second fixed contact parts 30b. The first movable contact part 28a is longer than the second movable contact part 28b in the top-bottom direction.

As shown in FIGS. 4 and 5, when the switches 27 are pressed by the switch press parts 8a, 11a, and 14a of the first white keys 8, second white keys 11, and black keys 14, the domal parts 27a are elastically deformed and dented. Firstly, the first movable contact part 28a contacts the first fixed contact parts 30a on the switch board 20. Thereafter, with a time difference, the second movable contact part 28b contacts the second fixed contact parts 30b on the switch board 20. Thus, the touch response function is realized. That is, when the domal part 27a is elastically deformed and dented, the first movable contact part 28a contacts the first fixed contact parts 30a, and thereafter the second movable contact part 28b contacts the second fixed contact parts 30b with a time difference corresponding to the key press strength of the key (first white keys 8, second white keys 11, and black keys 14). Accordingly, each switch 27 outputs a musical sound signal having a volume corresponding to the key press strength.

The reinforcement member 17 includes a stopper attachment 231. As shown in FIGS. 3 and 4, to the stopper attachment 231, an upper limit stopper 31 made of felt or the like is attached. The upper limit stopper 31 determines the upper limit position of the first white keys 8, second white keys 11, and black keys 14 of the keyboard unit 4. The stopper attachment 231 is part of a hook 23. The hook 23 is formed by bending the reinforcement member 17 at the front side of the board attachment part 22 (the right side in FIG. 4). The stopper attachment 231 projects upward beyond the switch board 20. The stopper attachment 231 projects substantially in the horizontal direction toward the front side of the first white keys 8, second white keys 11, and black keys 14.

As shown in FIGS. 3 and 4, the upper limit stopper 31 is attached to the bottom surface of the stopper attachment 231. Each of the first white keys 8, second white keys 11, and black keys 14 has a stopper contact part 32 that is separably in contact with the upper limit stopper 31 from below. Thus, the upper position of the first white keys 8, second white keys 11, and black keys 14 is restricted by the upper limit stopper 31. As shown in FIG. 4, the position of the lowest part of the stopper attachment 231 is higher than the bottom surface of the switch board 20 by a height difference h1. Similarly, the position of the lowest part of the upper limit stopper 31 is higher than the bottom surface of the switch board 20 by a height difference h2. With the height differences h1 and h2, the stopper attachment 231 and the upper limit stopper 31 are provided along the key arrangement direction. Such an upper limit stopper 31 allows long strokes of the first white keys 8, second white keys 11, and black keys 14 in the top-bottom direction when these keys are pressed and allows the switches 27 to have the touch response function.

As shown in FIGS. 3 and 4, the stopper contact part 32 of each of the first white keys 8 and second white keys 11 hangs down from around the middle position in the front-back direction of the first white key 8/second white key 11 (i.e., the position corresponding to the front end of the black keys 14) and protrudes toward the back side of the first white key 8/second white key 11 from the bottom end of the hanging-down portion. The stopper contact part 32 extends under the upper limit stopper 31 to be separably in contact with the bottom surface of the upper limit stopper 31. The stopper contact part 32 of each of the black keys 14 hangs down from the front-end position of the black keys 14 and protrudes toward the back side of the black keys 14 from the hanging-down portion. Similarly to the first white keys 8 and second white keys 11, the stopper contact part 32 of the black key 14 extends under the upper limit stopper 31 to be separably in contact with the bottom surface of the upper limit stopper 31.

A lower limit stopper 33 made of felt or the like is provided along the key arrangement direction at the bottom of the lower case 2, as shown in FIGS. 3 and 4. When the first white keys 8, second white keys 11, and black keys 14 are pressed, the stopper contact parts 32 of the respective first white keys 8, second white keys 11, and black keys 14 separably contact the lower limit stopper 33 from above. Thus, the lower limit stopper 33 determines the lower limit position of the first white keys 8, second white keys 11, and black keys 14.

Such a keyboard instrument is thin. The height T (see FIG. 3) of the keyboard instrument from the bottom surface of the lower case 2 to the top surface of the black keys 14 is approximately in a range of 26 mm to 1 mm. Further, according to the keyboard instrument, the key width H1 (see FIG. 2) in the key arrangement direction of each first white key 8 and second white key 11 is approximately in a range of 17.4 mm to 1 mm; and the key width H2 (see FIG. 2) in the key arrangement direction of each black key 14 is approximately in a range of 8.5 mm to 1 mm. The length S1 (see FIG. 3) in the front-back direction from the switch press parts 8a and 11a of the first white keys 8 and second white keys 11 to the front ends of the first white keys 8 and second white keys 11 is approximately in a range of 60.4 mm to 1 mm.

The length S2 (see FIG. 3) in the front-back direction from the switch press parts 14a of the black keys 14 to the front ends of the black keys 14 is approximately in a range of 23.4 mm to 1 mm. Therefore, the length S3 in the front-back direction from the front ends of the black keys 14 to the front ends of the first white keys 8 and second white keys 11 is approximately in a range of 37 mm to 1 mm. Thus, the keyboard instrument secures a wide keystroke area. A player can comfortably place his/her fingers on the first white keys 8, second white keys 11, and black keys 14 in playing the instrument and easily press the keys 8, 11, and 14.

The following is the description of how to assemble the keyboard instrument.

The method of assembling the keyboard instrument includes first to third processes. In the first process, the keyboard unit 4 is assembled by mounting the switch board 20, the first white keys 8, the second white keys 11, and the black keys 14 on the component attachment member 18 and by attaching the reinforcement member 17 under the component attachment member 18. In the second process, the keyboard unit 4 is combined with the lower case 2. In the third process, the upper case 3 is attached to the lower case combined with the keyboard unit 4, so that the instrument case 1 is assembled.

In the first process, the switches 27 are attached to the switch board 20 beforehand, and the switch board 20 is screwed to the board attachment part 22 of the component attachment member 18. Next, the upper limit stopper 31 is attached to the bottom surface of the stopper attachment 231, which is positioned higher than the switch board 20, of the reinforcement member 17. In this state, the component attachment member 18 is screwed to the reinforcement member 17. Next, the first white key unit 5, the second white key unit 6, and the black key unit 7 are attached to the component attachment member 18.

Herein, the second white keys 11 of the second white key unit 6 are placed between the first white keys 8 of the first white key unit 5 from above, and the second key connection part 13 of the second white key unit 6 is laid on the first key connection part 10 of the first white key unit 5. In this state, the first key connection part 10 and the second key connection part 13 are placed on the key attachment part 21 of the component attachment member 18; and the first white keys 8 and second white keys 11 are placed above the switch board 20. Herein, the stopper contact parts 32 of the respective first white keys 8 and second white keys 11 are inserted under the upper limit stopper 31, which is provided on the bottom surface of the stopper attachment 231 of the reinforcement member 17; and the switch press parts 8a and 11a of the respective first white keys 8 and the second white keys 11 are disposed to correspond to the switches 27 on the switch board 20.

In this state, the black keys 14 of the black key unit 7 are inserted between the first white keys 8 of the first white key unit 5 and the second white keys 11 of the second white key unit 6 from above. Herein, the stopper contact parts 32 of the respective black keys 14 are inserted under the upper limit stopper 31, which is provided on the bottom surface of the stopper attachment 231 of the reinforcement member 17; and the switch press parts 14a of the respective black keys 14 are disposed to correspond to the switches 27 on the switch board 20. The third key connection part 16 of the black key unit 7 is laid on the second key connection part 13 of the second white key unit 6. Herein, the pair of downward protrusions 16a on the third key connection part 16 of the black key unit 7 engages with the pair of upward protrusions 13a on the top surface of the second key connection part 13 of the second white key unit 6. Thus, the position of the third key connection part 16 is determined on the second key connection part 13.

The first to third key connection parts 10, 13, and 16 laid on each other are then arranged on the base 24 of the component attachment member 18. In this state, the shanks 26b of the screws 26 are inserted to the screw insertion holes 4a of the first to third key connection parts 10, 13, and 16; and the screw portions 26c of the screws 26 are screwed to the screw holes 25a of the bosses 25 and tightened. Accordingly, the first to third key connection parts 10, 13, and 16 are pressed against the base 24 by the heads 26a of the screws 26. Thus, the first white key unit 5, second white key unit 6, and black key unit 7 are mounted on the base 24. Herein, the first bending parts 9, the second bending parts 12, and the third bending parts 15 are separate from each other by a certain distance in the top-bottom direction and are offset from each other in the key arrangement direction. Thus, the first to third bending parts 9, 12, and 15 are arranged so as to avoid contact with each other. Thus, the keyboard unit 4 is assembled.

In the second process, the reinforcement member 17 of the keyboard unit 4 is placed on the inner bottom of the lower case 2 and screwed to the lower case 2. Thus, the lower case 2 is reinforced by the reinforcement member 17 and prevented from bending and deforming. Herein, the lower limit stopper 33 is attached beforehand to the inner bottom of the lower case 2 that comes under the stopper contact parts 32 of the first white keys 8, second white keys 11, and black keys 14. Thus, the keyboard unit 4 is attached to the inside of the lower case 2.

In the third process, the upper case 3 is placed on the lower case 2 and attached to the lower case 2 with non-illustrated screws. Herein, the first white key unit 5, the second white key unit 6, and the black key unit 7 are arranged in the instrument case 1 in the state where the first white keys 8, the second white keys 11, and the black keys 14 are exposed upward through the opening 3a of the upper case 3 except the back parts of the keys 8, 11, and 14. Thus, the thin keyboard instrument is assembled. The part corresponding to the keyboard unit 4 is substantially half the A4 size, and the entire instrument is substantially the A4 size.

The following is the description of how the assembled keyboard instrument is played.

When the first white keys 8, second white keys 11, and black keys 14 of the keyboard unit 4 are pressed, the first bending parts 9 of the pressed first white keys 8, the second bending parts 12 of the pressed second white keys 11, and the third bending parts 15 of the pressed black keys 14 are bent and deformed. The pressed first white keys 8, second white keys 11, and black keys 14 swing downward on the first to third bending parts 9, 12, and 15 as a center.

The switch press parts 8a, 11a, and 14a of the first white keys 8, second white keys 11, and black keys 14 press the corresponding switches 27 on the switch board 20, so that the switches 27 perform switch operations. Herein, the domal part 27a of each switch 27 is elastically deformed and dented, so that the first movable contact part 28a in the domal part 27a contacts the first fixed contact parts 30a on the switch board 20. Thereafter, the second movable contact part 28b in the domal part 27a contacts the second fixed contact parts 30b on the switch board 20 with a time difference corresponding to the key press strength of the key (first white keys 8, second white keys 11, and black keys 14). Thus, the touch response function is realized. A musical sound corresponding to the key press strength is output from a non-illustrated speaker. Thereafter, the stopper contact parts 32 of the respective pressed first white keys 8, second white keys 11, and black keys 14 contact the lower limit stopper 33. Thus, the lowest limit position of the pressed first white keys 8, second white keys 11, and black keys 14 is determined.

When the pressed white keys 8, second white keys 11, and black keys 14 return to their initial positions, the pressed first white keys 8, second white keys 11, and black keys 14 swing upward on the first to third bending parts 9, 12, and 15 as a center by the elastic restoring force of the domal parts 27a of the pressed switches 27 and the elastic restoring force of the first to third bending parts 9, 12 and 15. The stopper contact parts 32 of the pressed first white keys 8, second white keys 11, and black keys 14 contact the upper limit stopper 31, so that the upper limit position of the keys 8, 11, and 14 is determined. Thus, the pressed first white keys 8, second white keys 11, and black keys 14 return to their initial positions. Herein, the domal part 27a of the pressed switch 27 elastically returns to its initial form, and the bent and deformed first to third bending parts 9, 12, and 15 elastically return to their initial positions.

According to a keyboard device disclosed in JP 2021-18267A, the board attachment part and the key attachment part are provided to the lower case; the switch board is attached to the board attachment part; and the keys are attached to the key attachment part in the state of being arranged above the switch board. According to such a keyboard device, in arranging the keys above the switch board, the stopper contact parts of the respective keys need to be inserted under the upper limit stopper of the stopper attachment that is provided to the lower case and positioned below the switch board. When such a keyboard device is thin, it is difficult to insert the stopper contact parts of the keys under the upper limit stopper. This makes the assembly work difficult, and a thinner device cannot be manufactured.

On the other hand, according to the present disclosure, the keyboard instrument as a keyboard device includes: the lower case 2; the switch board 20 disposed above the lower case 2; the first white keys 8, the second white keys 11, and the black keys 14 disposed above the switch board 20; the reinforcement member 17 disposed between the lower case 2 and the switch board 20; and the stopper attachment 231 unitarily formed with the reinforcement member 17. The stopper attachment 231 is disposed at a position higher than the switch board 20. The keyboard instrument having such a structure can be made thin and easily assembled.

According to the keyboard instrument, the stopper attachment 231 is at a position higher than the switch board 20. Therefore, even when the keyboard instrument is thin, the stopper contact parts 32 of the first white keys 8, second white keys 11, and black keys 14 can be easily and appropriately inserted under the stopper attachment 231 of the reinforcement member 17 in arranging the first white keys 8, second white keys 11, and black keys 14 above the switch board 20. Thus, the keyboard instrument can be made thin and easily assembled.

According to the keyboard instrument, the switches 27 are arranged between the switch board 20 and the first white keys 8, second white keys 11, and black keys 14. Therefore, the switches 27 can be certainly and appropriately switched and operated in response to the pressing operations on the first white keys 8, second white keys 11, and black keys 14. Accordingly, good musical sounds are generated in response to the pressing operations of the first white keys 8, second white keys 11, and black keys 14 in a performance.

For a thinner keyboard instrument, it is desirable that the stopper attachment 231 be at a higher position. However, the switches 27 cannot be operated when the stopper attachment 231 is at a high position. Therefore, the upper limit position of the stopper attachment 231 is determined so as to secure the strokes of the switching operations. It is desirable that the stopper attachment 231 be at a position higher than the switch board 20.

According to the keyboard instrument, the reinforcement member 17 is formed of a rigid metal plate. Therefore, the reinforcement member 17 can be made thin while maintaining rigidity. Accordingly, the switch board 20, the first white keys 8, the second white keys 11, and the black keys 14 can be certainly and appropriately mounted on the reinforcement member 17. Further, the reinforcement member 17 can reinforce the lower case 2. Thus, the instrument case 1 is less likely to bend. This prevents the stopper contact parts 32 of the first white keys 8, second white keys 11, and black keys 14 from escaping from under the stopper attachment 231 of the reinforcement member 17.

According to the keyboard instrument, the stopper attachment 231 of the reinforcement member 17 protrudes upward beyond the switch board 20 and toward the front side of the first white keys 8, second white keys 11, and black keys 14. Thus, the rigidity of the hook 23 is secured, and the rigid stopper attachment 231 can be formed. Accordingly, the upper limit stopper 31 (e.g., felt) can be appropriately attached to the bottom surface of the stopper attachment 231.

According to the keyboard instrument, the upper limit stopper 31 is attached to the bottom surface of the stopper attachment 231. The stopper contact parts 32 of the respective first white keys 8, second white keys 11, and black keys 14 are separably in contact with the upper limit stopper 31 from below. In the initial state where the keys are not pressed, the stopper contact parts 32 of the keys are in contact with the bottom surface of the upper limit stopper 31. Thus, the first white keys 8, second white keys 11, and black keys 14 can be certainly and appropriately positioned at their initial positions.

According to the keyboard instrument, the lowest part of the upper limit stopper 31 is at a position higher than the bottom surface of the switch board 20. According to such a configuration, the upper limit position of the first white keys 8, second white keys 11, and black keys 14 can be set to a high position. This allows longer strokes in the top-bottom direction of the first white keys 8, second white keys 11, and black keys 14 when the keys are pressed and thereby gives the touch response function to the switches 27 of the switch board 20. Accordingly, good musical sounds are generated with volumes corresponding to the key press operations.

According to the keyboard instrument, the keyboard unit 4 is assembled by mounting the switch board 20, the first white keys 8, the second white keys 11, and the black keys 14 on the reinforcement member 17. Further, the keyboard unit 4 is attached to the lower case 2 by arranging and attaching the reinforcement member 17 onto the lower case 2. Since the switch board 20, the first white keys 8, the second white keys 11, and the black keys 14 can be attached to the reinforcement member 17 before the keyboard unit 4 is combined with the lower case 2, the stopper contact parts 32 of the first white keys 8, second white keys 11, and black keys 14 can be easily and appropriately inserted under the stopper attachment 231 of the reinforcement member 17. Thus, the assembly work can be improved.

Further, the keyboard instrument includes the component attachment member 18 that is mounted on the reinforcement member 17 and to which the switch board 20, the first white keys 8, second white keys 11, and black keys 14 are attached. The component attachment member 18 is reinforced by the reinforcement member 17. Thus, the switch board 20 can be easily and appropriately mounted on the component attachment member 18. Further, the first white keys 8, second white keys 11, and black keys 14 can be easily and appropriately mounted on the component attachment member 18.

Further, the keyboard instrument assembly method includes the first and second processes. In the first process, the keyboard unit 4 is assembled by attaching the reinforcement member 17 under the component attachment member 18 on which the switch board 20, the first white keys 8, the second white keys 11, and the black keys 14 have been mounted. In the second process, the keyboard unit 4 is combined with the lower case 2. Thus, the keyboard instrument can be easily assembled and can be made thin.

According to the keyboard instrument assembly method, in arranging the first white keys 8, second white keys 11, and black keys 14 above the switch board 20 in the first process, the stopper contact parts 32 of the first white keys 8, second white keys 11, and black keys 14 can be inserted under the stopper attachment 231 of the reinforcement member 17. Therefore, the keyboard unit 4 can be easily assembled. Further, in the second process, the keyboard unit 4 is combined with the lower case 2. Thus, the keyboard instrument can be easily assembled and can be made thin.

According to the keyboard instrument assembly method, in the first process, the upper limit stopper 31 is attached to the bottom surface of the stopper attachment 231, which is positioned higher than the switch board 20, of the reinforcement member 17; in the state where the stopper contact parts 32 of the first white keys 8, second white keys 11, and black keys 14 are inserted under the upper limit stopper 31, the first white keys 8, second white keys 11, and black keys 14 are mounted on the component attachment member 18; and the reinforcement member 17 is provided under the component attachment member 18. Thus, the stopper contact parts 32 of the first white keys 8, second white keys 11, and black keys 14 can be easily and appropriately inserted under the upper limit stopper 31. Thus, the first white keys 8, the second white keys 11, and the black keys 14 can be easily and appropriately mounted on the reinforcement member 17.

According to the keyboard instrument assembly method, in the second process, the reinforcement member 17 of the keyboard unit 4 is arranged on and attached to the lower case 2. Thus, the keyboard unit 4 can be easily and appropriately combined with the lower case 2, and the keyboard instrument can be easily and appropriately assembled. Further, the lower case 2 can be reinforced by the reinforcement member 17.

The keyboard instrument assembly method further includes the third process in which the upper case 3 is attached to the lower case 2 that has been combined with the keyboard unit 4 in the second process. Thus, the instrument case 1 can be easily assembled by simply laying and attaching the upper case 3 onto the lower case 2 combined with the keyboard unit 4. Further, since the instrument case 1 is reinforced by the reinforcement member 17, the instrument case 1 is less likely to bend. This prevents the keys from escaping.

1. A keyboard device comprising:
a lower case;
a board disposed above the lower case;
keys disposed above the board;
a reinforcement member disposed between the lower case and the board; and
a stopper attachment that is part of the reinforcement member,
wherein the stopper attachment is at a position higher than the board.

2. A keyboard device comprising:
a lower case;
a board disposed above the lower case;
keys disposed above the board; and
a reinforcement member disposed between the lower case and the board,
wherein the reinforcement member includes a stopper attachment that is a bent portion of the reinforcement member.

3. The keyboard device according to claim 1, further comprising at least one switch between the board and the keys.

4. The keyboard device according to claim 1, wherein the reinforcement member is formed of a metal plate.

5. The keyboard device according to claim 4, wherein the stopper attachment is a bent portion of the reinforcement member, which is formed of the metal plate.

6. The keyboard device according to claim 1, wherein the stopper attachment protrudes upward beyond the board and protrudes toward a front side of the keys.

7. The keyboard device according to claim 6, wherein:
at a bottom surface of the stopper attachment, an upper limit stopper is provided,
each of the keys is provided with a stopper contact part, and
the stopper contact part is separably in contact with the upper limit stopper from below.

8. The keyboard device according to claim 7, wherein a lowest part of the upper limit stopper is at a position higher than a bottom surface of the board.

9. The keyboard device according to claim 1, further comprising a component attachment member to which the board and the keys are attached and that is mounted on the reinforcement member.

10. A keyboard device assembly method comprising:
a first process of assembling a keyboard unit by providing a reinforcement member under a component attachment member on which a board and keys have been mounted; and
a second process of combining the keyboard unit with a lower case.

11. The keyboard device assembly method according to claim 10, wherein in the first process,
an upper limit stopper is attached to a bottom surface of a stopper attachment of the reinforcement member, the stopper attachment being at a position higher than the board,
in a state where stopper contact parts provided to the respective keys are inserted and arranged under the upper limit stopper, the keys are mounted on the component attachment member, and
the reinforcement member is provided under the component attachment member.

12. The keyboard device assembly method according to claim 10, wherein in the second process, the reinforcement member of the keyboard unit is mounted on the lower case.

13. The keyboard device assembly method according to claim 10, further comprising a third process, wherein
in the third process, an upper case is mounted on the lower case that has been combined with the keyboard unit in the second process.
